(19) United States
(12) Patent Application Publication
(10) Pub. No.: US 2007/0165336 A1
(43) Pub. Date: Jul. 19, 2007

(54) MAGNETIC DETECTING DEVICE HAVING LAMINATED SEED LAYER

(75) Inventors: Kazumi Kamai, Ishikawa-ken (JP); Naoya Hasegawa, Niigata-ken (JP); Eiji Umetsu, Niigata-ken (JP); Kazuaki Ikarashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/623,671

(22) Filed: Jan. 16, 2007

(30) Foreign Application Priority Data
Jan. 18, 2006 (JP) 2006-009672

(51) Int. Cl. G11B 5/127

(52) U.S. Cl. 360/324.1

(57) ABSTRACT

A magnetic detecting device is provided. The magnetic detecting device includes a magnetoresistive effect part having a fixed magnetic layer, and a free magnetic layer which faces the fixed magnetic layer with a nonmagnetic material layer therebetween and which varies in magnetization by an external magnetic field. A seed layer is provided below the magnetoresistive effect part. The seed layer includes an Al layer laminated on an NiFeCr layer.

This patent document claims the benefit of Japanese Patent Application No. 2005-009672 filed on Jan. 18, 2006, which is hereby incorporated by reference.

### BACKGROUND

1. Field

The present embodiments relate to a magnetic detecting device having a laminated seed layer.

2. Related Art

Japanese Unexamined Patent Application Publication Nos. 2005-203572, 2003-174217, 2003-299726, and 2002-232035 disclose a spin-valve-type thin film device, which includes a seed layer of NiFeCr formed below a magnetoresistive effect part having an antiferromagnetic layer, a fixed magnetic layer, a nonmagnetic material layer, and a free magnetic layer.

It is described in Paragraph [0042] of Japanese Unexamined Patent Application Publication No. 2005-203572 that “It is preferable that the seed layer 33 has a single-layer structure of a magnetic material layer or a nonmagnetic material layer which is preferentially oriented to the (111) plane of a face-centered cubic crystal or the (110) plane of a body-centered cubic crystal. Thereby, the crystals of the antiferromagnetic layer 34 can be preferentially oriented to the (111) plane, and the resistance changing rate of the magnetic detecting device can be enhanced.”

A variation in the resistance changing rate (ΔR/R) with respect to the film thickness of the seed layer was large in the magnetic detecting device using a seed layer formed of NiFeCr.

As shown in the experiment as described below, when a seed layer formed of NiFeCr is used, the peak value of the resistance changing rate (ΔR/R) can be obtained if the film thickness of the seed layer is set to about 38 Å.

However, even if the film thickness of the seed layer becomes slightly smaller than 38 Å, the resistance changing rate (ΔR/R) declines abruptly. Therefore, in a case where the seed layer is formed in a single-layer structure of NiFeCr, the seed layer was formed to have a film thickness (as described in Paragraph [0004] of Japanese Unexamined Patent Application Publication No. 2005-203572, 2003-174217 that the seed layer is formed to have a film thickness of 60 Å) of about 40 Å to 50 Å in actuality.

In order to enhance the seed effect to improve the resistance changing rate (ΔR/R) in the related art where the seed layer is formed in the single-layer structure of NiFeCr, for example, an attempt to improve the compositional ratio of NiFeCr has been made. However, there is a need for improving the structure of the seed layer itself in obtaining a higher and stable resistance changing rate (ΔR/R).

### SUMMARY

The present embodiments may obviate one or more of the drawbacks or limitations inherent in the related art. For example, in one embodiment, a magnetic detecting device is capable of stably obtaining a high resistance changing rate (ΔR/R) as compared with the related art.

In one embodiment, a magnetic detecting device includes a magnetoresistive effect part having a fixed magnetic layer whose magnetization direction is fixed in a predetermined direction, and a free magnetic layer that faces the fixed magnetic layer with a nonmagnetic material layer therebetween and which varies in magnetization by an external magnetic field; and a seed layer provided below the magnetoresistive effect part. In this embodiment, the seed layer is formed in a structure in which an Al layer is laminated on an NiFeCr layer.

This embodiment makes it possible to obtain a high resistance changing rate (ΔR/R) as compared with the related art in which a seed layer is formed in a single-layer structure of NiFeCr.

In another embodiment, a magnetic detecting device includes a magnetoresistive effect part having a fixed magnetic layer whose magnetization direction is fixed in a predetermined direction, and a free magnetic layer which faces the fixed magnetic layer with a nonmagnetic material layer therebetween and which varies in magnetization by an external magnetic field; and a seed layer provided below the magnetoresistive effect part. In this embodiment, the seed layer is formed in a structure in which a Co layer is laminated on an NiFeCr layer, and an Al layer is laminated on the Co layer.

In this embodiment, the seed layer is formed in a three-layer structure of an NiFeCr layer, a Co layer, and an Al layer. This makes it possible to obtain a high resistance changing rate (ΔR/R) as compared with the related art in which a seed layer is formed in a single-layer structure of NiFeCr. This embodiment is preferable because a high resistance changing rate (ΔR/R) can be obtained stably as compared with the related art in which a seed layer is formed in a two-layer structure of an NiFeCr layer and an Al layer.

In one embodiment, the seed layer is formed to have a film thickness of 38 Å or more and 50 Å or less. This film thickness range is approximately equal to that in the related art in which a seed layer is formed in a single-layer structure of NiFeCr. In this embodiment, a resistance changing rate (ΔR/R) which is higher than that in the related art can be obtained without changing the film thickness of the seed layer.

In one embodiment, the Al layer is formed to have a film thickness of 4 Å or more and 8 Å or less. In this embodiment, the Co layer is formed to have a film thickness of 4 Å or more and 6 Å or less. By adjusting the film thickness of the Al layer and the film thickness of the Co layer to the above ranges, a proper high resistance changing rate (ΔR/R) can be obtained as compared with the related art in which a seed layer is formed in a single-layer structure.

In another embodiment, a magnetic detecting device includes a magnetoresistive effect part having a fixed magnetic layer whose magnetization direction is fixed in a predetermined direction, and a free magnetic layer which faces the fixed magnetic layer with a nonmagnetic material layer therebetween and which varies in magnetization by an external magnetic field; and a seed layer provided below the magnetoresistive effect part. In this embodiment, the seed layer is formed mainly of NiFeCr, and the concentration of Al in a surface region of the seed layer is higher than the concentration of Al in the other regions of the seed layer.

This makes it possible to obtain a high resistance changing rate (ΔR/R) as compared with the related art in which a seed layer is formed in a single-layer structure of NiFeCr.

In this embodiment, a magnetic detecting device includes a magnetoresistive effect part having a fixed magnetic layer whose magnetization direction is fixed in a predetermined direction, and a free magnetic layer which faces the fixed magnetic layer with a nonmagnetic material layer therebetween and which varies in magnetization by an external magnetic field; and a seed layer provided below the magnetoresistive effect part. In this embodiment, a high-concentration Co region having a higher Co concentration than the other regions of the seed region and a high-concentration Al region provided above the high-concentration Co region and having a higher Al concentration than the other regions of the seed layer exist in a surface region of the seed layer.

In this embodiment, it is possible to obtain a high resistance changing rate (ΔR/R) as compared with the related art in which a seed layer is formed in a single-layer structure of NiFeCr. This embodiment is preferable in that a higher resistance changing rate (ΔR/R) can be obtained stably as compared with an aspect in which the high-concentration Al layer exists in a surface region of a seed layer formed mainly of NiFeCr, but the high-concentration Co layer does not exist in the surface region.

In one embodiment, it is preferable that the seed layer be formed to have a film thickness of 38 Å or more and 50 Å or less. This film thickness range is approximately equal to that in the related art in which a seed layer is formed in a single-layer structure of NiFeCr. In one embodiment, a resistance changing rate (ΔR/R), which is higher than that in the related art, can be obtained without changing the film thickness of the seed layer.

In one embodiment, an antiferromagnetic layer constituting the magnetoresistive effect part is formed on the seed layer, and the fixed magnetic layer, the nonmagnetic intermediate layer, and the free magnetic layer are laminated on the antiferromagnetic layer. This laminated structure makes it possible to exhibit the seed effect more properly, and to obtain a high resistance changing rate (ΔR/R)

In one embodiment, a seed layer is formed below a magnetoresistive effect part which exhibits a magnetoresistive effect in a laminated structure of an NiFeCr layer and an Al layer, or in a laminated structure of an NiFeCr layer, a Co layer, and an Al layer, a high resistance changing rate (ΔR/R) can be obtained as compared with the related art in which a seed layer is formed in a single-layer structure of NiFeCr.

### BRIEF DESCRIPTION OF THE DRAWINGS

FIG. 1 is a sectional view of one embodiment of a thin film magnetic head including a magnetic detecting device;

FIG. 2 is a partially enlarged schematic view showing a seed layer of the magnetic detecting device shown in FIG. 1, and a distribution chart showing the Al concentration and Co concentration of the seed layer;

FIG. 3 is a sectional view of one embodiment of a thin film magnetic head including a magnetic detecting device;

FIG. 4 is a partially enlarged schematic view showing a seed layer of the magnetic detecting device shown in FIG. 3 and a distribution chart showing the Al concentration of the seed layer;

FIG. 5 is a graph showing the relationship between the film thickness of a seed layer in each specimen of a single-layer seed (NiFeCr), a two-layer seed (NiFeCr/Al), and a three-layer seed (NiFeCr/Co/Al), and the minimum resistance value (min. Rs);

FIG. 6 is a graph showing the relationship between the film thickness of a seed layer in each specimen of a single-layer seed (NiFeCr), a two-layer seed (NiFeCr/Al), and a three-layer seed (NiFeCr/Co/Al), and the resistance changing rate (ΔR/R); and

FIG. 7 is an enlarged graph showing that the resistance changing rate (ΔR/R) on the axis of ordinate of FIG. 6 is narrowed to a range of 14.5 (%) to 15.9 (%).

### DETAILED DESCRIPTION

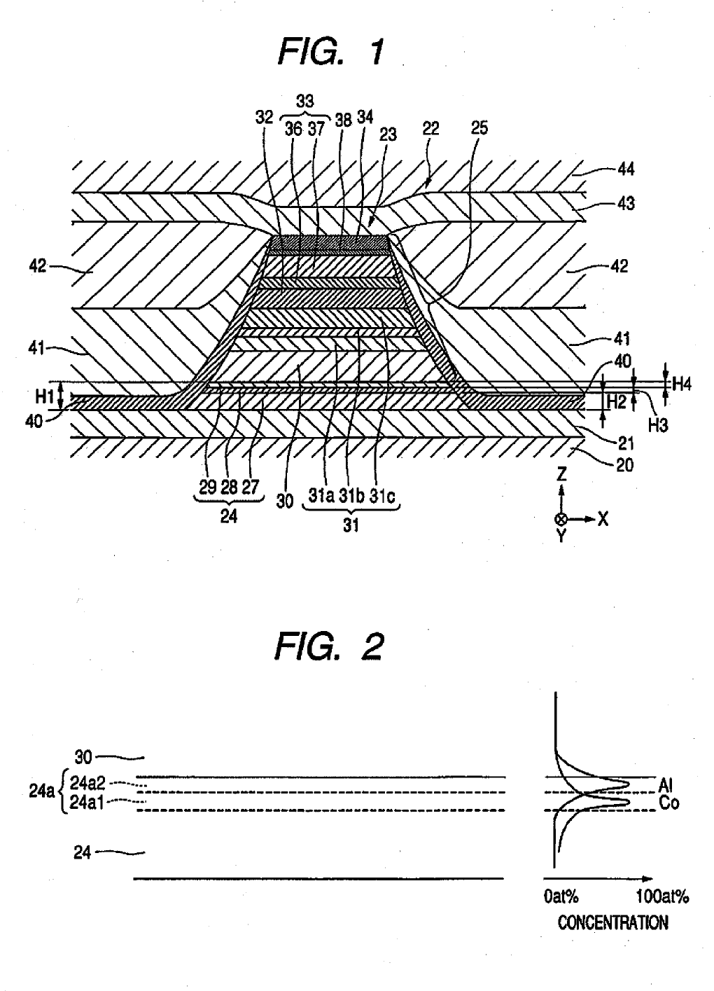

FIG. 1 is a sectional view of a thin film magnetic head (reproducing head) including a magnetic detecting device (spin-valve-type thin film device) of the present embodiment when being cut along a plane which is parallel to a surface facing a recording medium.

The spin-valve-type thin film device is provided at a trailing end of a floating-type slider provided in a hard disk apparatus to detect a recording magnetic field of, for example, a hard disk.

In the drawings, the X-direction denotes a track width direction. In the drawings, the Y-direction denotes a height direction. In the drawings, the Z-direction denotes a depth direction. The Z-direction is the moving direction of a magnetic recording medium, such as a hard disk, and the laminating direction of each layer of the spin-valve-type thin film device. Each of the track width direction, the height direction, and the depth direction is in a relation orthogonal to the remaining two directions. The ‘surface facing a recording medium’ is a surface in a direction parallel to an X-Z plane.

In one embodiment, the thin film magnetic head includes a lower shielding layer 20 formed of a magnetic material, such as an NiFe alloy. The lower shielding layer 20 is formed in the lowest position of FIG. 1.

In one embodiment, as shown in FIG. 1, a lower gap layer 21 formed of an insulating material, for example, Al₂O₃, AlSiO, or SiO₂ is formed on the lower shielding layer 20.

A spin-valve-type thin film device 22 is formed on the lower gap layer 21. A laminate 23 is formed in a middle part of the spin-valve-type thin film device 22 in the track width direction (X-direction in the drawing).

The laminate 23 has a seed layer 24, and a magnetoresistive effect part 25.

In one embodiment, the seed layer 24 has a laminated structure of an NiFeCr layer 27, a Co layer 28 formed on the NiFeCr layer 27, and an Al layer 29 formed on the Co layer 28.

In one embodiment, the magnetoresistive effect part 25 is composed of an antiferromagnetic layer 30, a fixed magnetic layer 31, a nonmagnetic material layer 32, a free magnetic layer 33, and a protective layer 34 from the bottom.

The antiferromagnetic layer 30 is formed of an antiferromagnetic material containing an element X (where X is at least one element among Pt, Pd. Ir, Rh, Ru, or Os, and Mn, or an antiferromagnetic material containing the element X, an element X′ containing (where X′ is at least one element among Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, PO, or rare-earth elements), and Mn. For example, the antiferromagnetic layer 7 is formed of, for example, IrMn, or PtMn.

In the embodiment shown in FIG. 1, the fixed magnetic layer 31 is formed in a laminated ferrimagnetic structure. As shown in FIG. 1, the fixed magnetic layer 31 is configured such that a first magnetic layer 31a, a nonmagnetic intermediate layer 31b, and a second magnetic layer 31c are laminated in this order from the bottom.

Magnetization of the first magnetic layer 31a and the second magnetic layer 31c are fixed in a state non-parallel to each other by an exchange-coupled magnetic field at an interface between each of the first and second magnetic layers and the antiferromagnetic layer 30 and by an antiferromagnetic exchange-coupled magnetic field (RKKY interaction) via the nonmagnetic intermediate layer 31b. The first magnetic layer 31a and the second 25 magnetic layer 31c are formed of, for example, a ferromagnetic material, for example, CoFe, NiFe, or CoFeNi. The nonmagnetic intermediate layer 31b is formed of a nonmagnetic conductive material, for example, Ru, Rh, Ir, Cr, Re, or Cu.

The nonmagnetic material layer 32 is formed of, for example, Cu, Au, or Ag.

In one embodiment, the free magnetic layer 33 is composed of a soft magnetic layer 37 formed of a magnetic material, such as an NiFe alloy, and a diffusion preventive layer 36 which is made of CoFe or the like and is formed between soft magnetic layer 37 and the nonmagnetic material layer 32. The free magnetic layer 33 may be formed in a ferrimagnetic structure similarly to the fixed magnetic layer 31. In an alternative embodiment, the free magnetic layer is formed in a laminated structure of magnetic material layers, it may have a single-layer structure or a three-layer structure, not the above-mentioned two-layer structure.

On the free magnetic layer 33, a specular layer 38 is formed. The specular layer 38 is formed with, for example, an oxide layer formed by oxidation of the surface of the soft magnetic layer 37 which constitutes the free magnetic layer 33. The specular layer 38 may not be formed.

The protective layer 34 is formed of, for example, Ta. The protective layer 34 becomes Ta—O by natural oxidation.

As shown in FIG. 1, both lateral surfaces of the laminate 23 in the track width direction (X-direction) are formed with inclined surfaces or curved faces such that the dimension of the width of the laminate 23 in the track width direction is gradually reduced upward from the bottom. As shown in FIG. 1, the cross-section of the laminate 23 is formed in a substantially trapezoidal shape.

As shown in FIG. 1, a bias underlayer 40 is formed over the lower gap layer 21 and both the lateral surfaces of the laminate 23, a hard bias layer 41 is formed on the bias underlayer 40, and an electrode layer 42 is formed on the hard bias layer 41. The bias underlayer 40 is formed of, for example, Cr. The hard bias layer 41 is formed of a CoPt alloy or a CoCrPt alloy. The electrode layer 42 is formed of a conductive material, for example, Cr, W, Au, Rh, or α-Ta.

As shown in FIG. 1, an upper gap layer 43 is formed on the spin-valve-type thin film device 22, and an upper shielding layer 44 is formed on the upper gap layer 43. The upper gap layer 43 is formed of an insulating material, for example, Al₂O₃ or SiO₂, and the upper shielding layer 44 is formed of a magnetic material, such as NiFe.

The free magnetic layer 33 is magnetized in a direction parallel to the track width direction α-direction) by a biasing magnetic field to be supplied from the hard bias layer 41. Since the first magnetic layer 31a and the second magnetic layer 31c, which constitute the fixed magnetic layer 31, are magnetized in a non-parallel state in a direction parallel to the height direction, the magnetization direction of the free magnetic layer 33 and the magnetization direction of the second magnetic layer 31c are in an orthogonal relation to each other.

The magnetization direction of the free magnetic layer 33 changes depending on an external magnetic field. When the magnetization direction of the free magnetic layer 33 and the magnetization direction of the second magnetic layer 31c become parallel to each other, the resistance value of the laminate 23 is minimized (min, Rs), and when the magnetization direction of the free magnetic layer 33 and the magnetization direction of the second magnetic layer 31c are non-parallel to each other, the resistance value of the laminate 23 is maximized.

The characteristic parts of the spin-valve-type thin film device 22 in the present embodiment will now be described below.

As shown in FIG. 1, the seed layer 24 is formed in a three-layer structure in which the Co layer 28 is laminated on the NiFeCr layer 27, and the Al layer 29 is formed on the Co layer 28. Also, the antiferromagnetic layer 30 which constitutes the magnetoresistive effect part 25 is formed directly on the seed layer 24.

By forming the seed layer 24 in a three-layer structure of the NiFeCr layer 27, Co layer 28, and Al layer 29, as compared with the related art in which a seed layer is formed in a single-layer structure of NiFeCr, a seed effect can be exhibited effectively and a high resistance changing rate (ΔR/R) can be obtained stably. In this embodiment, the ‘seed effect’ is enhancing crystallinity, and particularly means that the crystals oriented in a direction (parallel to the X-Y plane) parallel to a film surface of each layer of the magnetoresistive effect part 25 to be formed on the seed layer 24 are preferentially oriented to the [111] plane.

In the present embodiment, the [111] orientation property of the NiFeCr layer 27 has been sufficiently improved by forming the seed layer 24 in a laminated structure of the NiFeCr layer 27, Co layer 28, and Al layer 29, thereby causing reorientation of the atoms in the NiFeCr layer 27.

In one embodiment, it is preferable that the NiFeCr layer 27 shown in FIG. 1 be formed to have a film thickness H2 of 38 Å or less. If the film thickness is 38 Å or less, in a single-layer structure of the NiFeCr layer 27, the crystallinity is insufficient and the seed effect declines greatly. In the present embodiment, the crystallinity is improved and the seed effect is improved, by laminating the Al layer 29 on the NiFeCr layer 27 having such insufficient crystallinity, thereby promoting reorientation of the atoms in the NiFeCr layer 27. For example, the Co layer 28 having a face-centered cubic structure (fcc structure) similarly to the NiFeCr layer 27 contributes greatly to the promotion of the reorientation of the atoms in the NiFeCr layer 27.

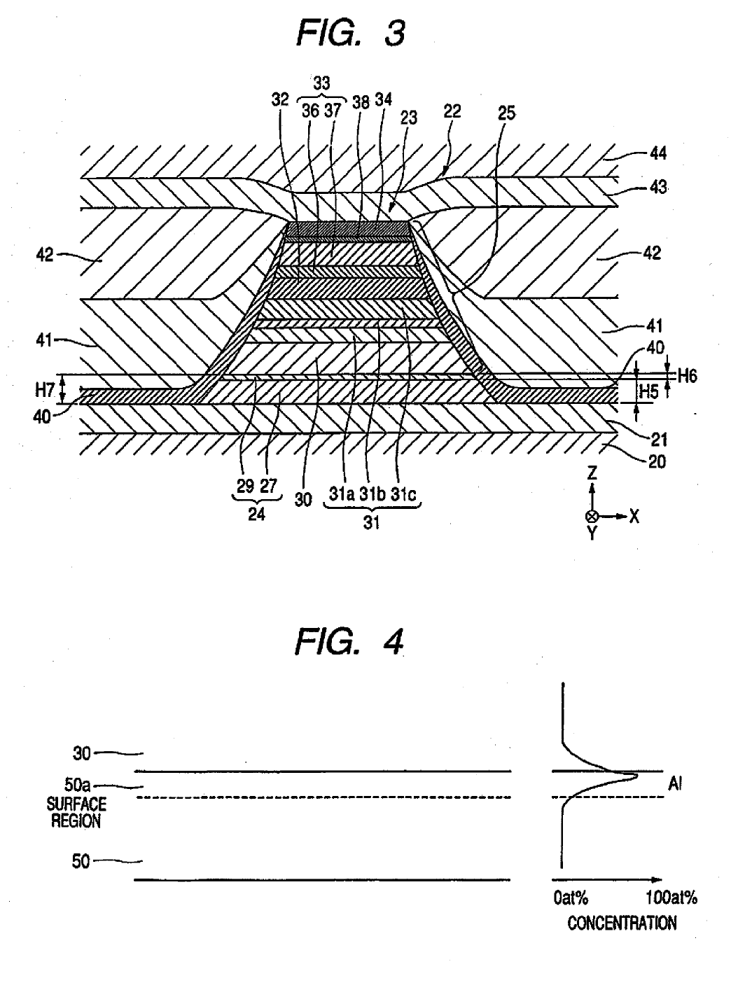

In one embodiment, the film thickness H2 of the NiFeCr layer 27 may be 38 Å or more. In this embodiment, however, the NiFeCr layer 27 is singly in a good crystalline state. The effects (of enhancing the crystallinity of the NiFeCr layer 27) obtained by overlapping of the Co layer 28 is not exhibited sufficiently, and the necessity for providing the Co layer 28 is weakened (in this case, as shown in FIG. 3, even in a two-layer structure of the NiFeCr layer 27 and Al layer 29, a high resistance changing rate (ΔR/R) is obtained, and the film thickness H2 of the NiFeCr layer 27 is increased. Thereby, since the loss of diversion to the seed layer 24 increases in a CIP-GMR, the resistance changing rate (ΔR/R) declines easily. As a result, it is believed that it is preferable that the film thickness H2 of the NiFeCr layer 27 be 38 Å or less. In this embodiment, it is preferable that the lower limit of the film thickness H2 of the NiFeCr layer 27 be 28 Å.

In one embodiment, the Al layer 29 maintains the interfacial state between itself and the antiferromagnetic layer 30 in a proper state. According to the experiment as described below, it is understood that a higher resistance changing rate (ΔR/R) can be obtained by forming the seed layer 24 in a three-layer structure of the NiFeCr layer 27, Co layer 28, and Al layer 29 rather than forming the seed layer in a two-layer structure of an NiF layer and a Co layer.

As shown in FIG. 1, the film thickness of the NiFeCr layer 27 is H2, the film thickness of the Co layer 28 is H3, the film thickness of the Al layer 29 is H4, and the film thickness H1 of the seed layer 24 is H2+H3+H4.

It is preferable that the seed layer 24 be formed to have a film thickness H1 of 38 Å or more and 50 Å or less. In the related art in which a seed layer is formed in a single-layer structure of NiFeCr, the shield layer is formed to have a film thickness of about 40 Å to 50 Å. In this embodiment, the seed layer 24 is formed to have almost the same film thickness as that in the related art. For example, in the present embodiment, a high resistance changing rate (ΔR/R) can be obtained more stably than the related art without changing the film thickness H of the seed layer 24 like the related art.

The film thickness H1 of the seed layer 24 is preferably 42 Å to 50 Å, and more preferably, 42 Å to 46 Å.

It is preferable that the Co layer 28 be formed to have a thickness H3 of 4 Å or more and 6 Å or less, and the Al layer 29 is formed to have a thickness H4 of 4 Å or more and 8 Å or less. It is more preferable that the film thickness H4 of the Al layer 29 be 6 Å or more and 8 Å or less. According to the experiment as described below, the film thickness H1 of the seed layer 24 is set to a range of 38 Å to 50 Å, and the Al layer 29 and Co layer 28 of the seed layer is set to a value within the above range, so that a high resistance changing rate (ΔR/R) can be obtained stably as compared with the related art in which a seed layer is formed in a single-layer structure of NiFeCr.

As described above, the Co layer 28 and the Al layer 29 are formed to have a significant small film thickness. There is a case that diffusion of elements occurs between the Co layer 28 and the underlying NiFeCr layer 27 or between the Al layer 29 and the overlying antiferromagnetic layer 30 due to thermal influence or the like.

In one embodiment, as shown in FIG. 2, the seed layer 24 is formed mainly of NiFeCr, and may be in a form in which a high-concentration Co region 24a1 having a higher Co concentration than the other regions exists in a lower region of the seed layer 24 and a high-concentration Al region 24a2 having a higher Al concentration than the other regions exists in an upper region of the surface region 24a (above the high-concentration Co region 24a1). As shown in FIG. 2, Co or Al is locally diffused even within the antiferromagnetic layer 30, and a region where the concentration of Co and the concentration of Al falls gradually from the upper side towards the lower side exists within the antiferromagnetic layer 30.

In addition, nano-beam property X-ray analysis (Nano-beam EDX) using a SIMS analyzer or a field-emission transmission electron microscopy (FE-TEM) is used for analysis of composition.

The NiFeCr layer 27 is expressed by the following compositional formula: {NiₓFe₁₋ₓ}_{y}Cr_{100-y}. In one embodiment, it is preferable that the Ni ratio ‘x’ be within a range of 0.7 to 1, and the at % ‘y’ is formed from NiFeCr within a range of 25 at % to 45 at %. The ‘Ni ratio x’ is expressed by atomic % of Ni/(atomic % of Ni+atomic % of Fe). For example, the NiFeCr layer 27 is formed from {Ni_{0.8}Fe_{0.2}}_{60at %}Cr_{40at %}.

In one embodiment, instead of the Co layer 28, a CoFe layer (where the compositional ratio of Co is 90 at % to less than 100 at %) may be formed on the NiFeCr layer 27. For example, the seed layer 24 may be formed in a three-layer structure of the NiFeCr layer 27, CoFe layer, and Al layer 29.

By setting the compositional ratio of the CoFe layer to a range 90 at % to 100 at % (excluding 100 at %), a high resistance changing rate (ΔR/R) can be obtained as compared with a case where the seed layer is formed in a single-layer structure of NIFeCr. For example, a higher resistance changing rate (ΔR/R) can be obtained stably by forming the seed layer 24 in a three-layer structure of the NiFeCr layer 27, CoFe layer, and Al layer 29 rather than forming the seed layer 24 in a three-layer structure of the NiFeCr layer 27, Co layer 28, and Al layer 29.

FIG. 3 is a sectional view of a thin film magnetic head (reproducing head) including a spin-valve-type thin film device having a structure different from that of FIG. 1 when it is cut along a plane which is parallel to a surface facing a recording medium.

In one embodiment, as shown in FIG. 3, a seed layer 50 is formed in a two-layer structure of the NiFeCr layer 27 and the Al layer 29, which is different from that of FIG. 1. In FIG. 3, the NiFeCr layer 27 is formed to have a film thickness H5, the Al layer 29 is formed to have a film thickness H6, and consequently the seed layer 50 is formed to have a film thickness H7 (H5+H6).

According to the experiment as described below, even in a case where the seed layer 50 is formed in a two-layer structure of the NiFeCr layer 27 and the Al layer 29, the resistance changing rate (‘ΔR/R) can be increased as compared with the related art in which a seed layer is formed in a single layer structure of NiFeCr.

As compared with the case in which the seed layer 24 is formed in the three-layer structure of the NiFeCr layer 27, Co layer 28, and Al layer 29, if the seed layer 50 is formed in a two-layer structure of the NiFeCr layer 27 and Al layer 29, the resistance changing rate (ΔR/R) becomes slightly smaller, and consequently, the stability of the resistance changing rate (ΔR/R) with respect to fluctuations in sheet thickness is also lowered slightly. However, the resistance changing rate (ΔR/R) can be increased as compared with a case where the seed layer is formed in a single-layer structure like the related art.

In one embodiment, the film thickness H2 of the seed layer 24 having a two-layer structure of the NiFeCr layer 27 and Al layer 29 be 38 Å or more and 50 Å or less. It is more preferable that the film thickness H7 be 42 Å to 50 Å, and it is furthermore preferable that the film thickness be 42 Å to 46 Å. In this embodiment, it is preferable that the film thickness H6 of the Al layer 29 be within a range of 4 Å to 8 Å, and it is more preferable that the film thickness H6 be within a range of 4 Å to 6 Å. Furthermore, it is preferable that the film thickness H5 of the NiFeCr layer 27 be 38 Å or more. It is believed that the Al layer 29 has small or little effect in enhancing the crystallinity of the NiFeCr layer 27, as compared with the Co layer 28 shown in FIG. 1, and it is therefore believed that it is necessary for the NiFeCr layer 27 to be in a good crystalline state even singly. It is therefore preferable that the film thickness H5 of the NiFeCr layer 27 be 38 Å or more.

In the present embodiment, the film thickness H7 of the seed layer 50 is set to a range of 38 Å to 50 Å. This film thickness range is approximately equal to that in the related art in which a seed layer is formed in a single-layer structure. In the present embodiment, a high resistance changing rate (ΔR/R) can be obtained as compared with the related art without changing the film thickness.

As described above, the Al layer 29 is formed to have a significantly small film thickness. There is a case that diffusion of elements occurs between the Al layer 29 and the underlying NiFeCr layer 27 or between the Al layer 29 and the overlying antiferromagnetic layer 30 due to thermal influence or the like. In one embodiment, as shown in FIG. 4, the seed layer 24 is formed mainly of NiFeCr, and may be in such a form that the concentration of Al becomes higher in the surface region 24a of the seed layer 24 than the other regions. As shown in FIG. 4, Al is locally diffused even within the antiferromagnetic layer 30, and a region where the concentration of Al falls gradually from the upper side towards the lower side exists within the antiferromagnetic layer 30.

In addition, nano-beam property X-ray analysis (Nano-beam EDX) using a SIMS analyzer or a field-emission transmission electron microscopy (FE-TEM) is used for analysis of composition.

A method of manufacturing the spin-valve-type thin film device in the present embodiment will now be described. After a lower gap layer 21 is formed on a lower shielding layer 20, a seed layer 24 formed in a three-layer structure of an NiFeCr layer 27, a Co layer 28, and an Al layer 29 is formed on the lower gap layer 21. Otherwise, a seed layer 24 formed in a two-layer structure of an NiFeCr layer 27 and an Al layer 29 is formed on the lower gap layer 21.

In one embodiment, a magnetoresistive effect part 25 composed of an antiferromagnetic layer 30, a fixed magnetic layer 31, a nonmagnetic material layer 32, a free magnetic layer 33, and a protective layer 34 is formed on the seed layer 24. In one embodiment, where the seed layer 24 is formed in the three-layer structure, the seed layer 24 is formed in a film thickness of preferably 38 Å to 50 Å (more preferably 42 Å to 50 Å, and furthermore preferably 42 Å to 46 Å), and the Co layer 28 of the seed layer is formed in a film thickness of 4 Å to 6 Å, and the Al layer 29 of the seed layer is formed in a film thickness of 4 Å to 8 Å (preferably 6 Å to 8 Å).

In one embodiment, where the seed layer 24 is formed in the two-layer structure, the seed layer 24 is formed in a film thickness of preferably 38 Å to 50 Å (more preferably 42 Å to 50 Å, and furthermore preferably 42 Å to 46 Å), and the Al layer 29 of the seed layer is formed in a film thickness of 4 Å to 8 Å (preferably 6 Å to 8 Å). When heat treatment is performed in a manufacturing process, for example, heat treatment in a magnetic field is formed in order to generate an exchange-coupled magnetic field (Hex) between the antiferromagnetic layer 30 and the fixed magnetic layer 31, the elements constituting the seed layer 24 are diffused, but a high-concentration Al region (in the case where the seed layer 24 is formed in the two-layer structure of the NiFeCr layer 27 and Al layer 29), or a high-concentration Co region 24a1 and a high-concentration Al region 24a2 (in the case where the seed layer 24 is formed in the three-layer structure of the NiFeCr layer 27, Co layer 28, and Al layer 29) exist(s) in a surface region 24a of the seed layer 24.

In other seed regions than the surface region 24a, NiFeCr as a main composition exists. Although the NiFeCr exists even in the surface region 24a, the concentration of the NiFeCr is significantly high in other seed regions than the surface region 24a.

After a laminate 23 formed from the seed layer 24 and the magnetoresistive effect part 25 is machined in a substantially trapezoidal shape as shown in FIG. 1, a bias underlayer 40, a hard bias layer 41, and an electrode layer 42 are laminated in this order from the bottom on both sides of the laminate 23 in the track width direction (X-direction).

In one embodiment, an upper gap layer 43 is formed on the protective layer 34 and the electrode layer 42, and further an upper shielding layer 44 is formed on the upper gap layer 43.

In one embodiment, the configuration of the seed layer 24 shown in FIG. 1 may be applied to a CPP (Current Perpendicular to the Plane)-GMR in which current is caused to flow to individual layers of a laminate constituting a spin-valve-type thin film device from a direction perpendicular to a film surface.

Although the magnetoresistive effect part 25 may be laminated, for example, in the order of a nonmagnetic material layer 32, a fixed magnetic layer 31, and an antiferromagnetic layer 30 from the bottom, the structure of FIG. 1 in which the antiferromagnetic layer 30 is formed below the free magnetic layer 33 is more preferable because the seed effect can be exhibited more properly, and a high resistance changing rate (ΔR/R) can be obtained stably.

### EXAMPLES

The spin-valve-type thin film device shown in FIG. 1 was formed. A laminate constituting the spin-valve-type thin film device was formed to have the following substrate film configuration. The substrate film configuration from the bottom was as follows: substrate/seed layer; [{Ni_{0.8}Fe_{0.2}}_{60at %}Cr_{40at %}]/Al or {Ni_{0.8}Fe_{0.2}}_{60at %}Cr_{40at %}/Co/Al]/antiferromagnetic layer; InMn(55)/fixed magnetic layer[Fe_{30at %}Co_{70at %}(14)]/Ru(8.7)/Co(22)]/nonmagnetic material layer/free magnetic layer; [Co_{90at %}Fe_{10at %}(12)/Co_{70at %}/Fe_{30at %}(4)/Ni_{80at %}Fe_{20at %}(13)/Co_{90at %}Fe_{10at %}(3)/protective layer; and Ta(16)]. Numerical numbers in parentheses represent film thicknesses, and the unit of the numbers is Å.

In an experiment, in a case where a seed layer is formed in the three-layer structure, a specimen in which the film thickness of a Co layer is fixed to 4 Å and the film thickness of an Al layer is fixed to 6 Å, a specimen in which the film thickness of a Co layer is fixed to 4 Å and the film thickness of an Al layer is fixed to 8 Å, and a specimen in which the film thickness of a Co layer is fixed to 6 Å and the film thickness of an Al layer is fixed to 6 Å are prepared, respectively.

In a case where the seed layer is formed in the two-layer structure, specimens in which the film thickness of an Al layer is fixed to 2 Å, 4 Å, 6 Å, and 8 Å are prepared, respectively. Then, while the film thickness (corresponding to the film thickness H1 of FIG. 1 and the film thickness H7 of FIG. 3) of each of the specimens is changed, the relationship between the film thickness of the seed layer and the minimum resistance value (min. Rs), and the relationship between the film thickness of the seed layer and the resistance changing rate (ΔR/R) were investigated, respectively. In addition, similarly to the above, an experiment was also performed on a spin-valve-type thin film device having a seed layer which is formed in the single-layer structure of NiFeCr.

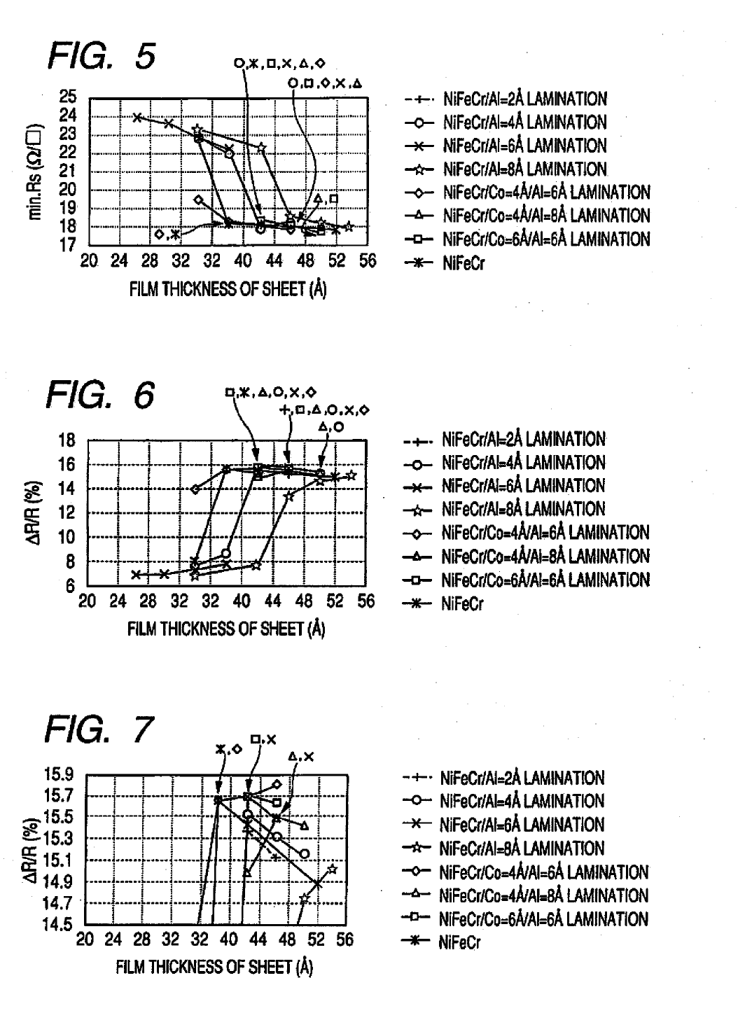

FIG. 5 is a graph showing the relationship between the film thickness of a seed layer and the minimum resistance value (min. Rs), and FIG. 6 is a graph showing the relationship between the film thickness of the seed layer and the resistance changing rate (ΔR/R).

In following description, a seed layer composed of NiFeCr/Co/Al is referred to as ‘three-layer seed,’and a seed layer composed of NiFeCr/Al is referred to as ‘two-layer seed,’ and a seed layer composed of NiFeCr is referred to as ‘single-layer seed.’

As shown in FIG. 5, if the film thickness of the seed layer is below 38 Å in a case where the single-layer seed is used, the minimum resistance value (min. Rs) rises abruptly. It is believed that this is because, if the film thickness of the seed layer is smaller than 38 Å in the case of the single-layer seed, the crystalline state of the seed layer becomes unstable (the [111] plane is not preferentially oriented properly in the film thickness direction), and consequently, the seed effect declines, and thereby the crystallinity of a laminate on the seed layer cannot be enhanced.

Alternatively, in a case where the three-layer seed is used, there is no great change in the dependency of the minimum resistance value (min. Rs) on the thickness of the seed as compared with the single-layer seed. Also, in the two-layer seed, even if the film thickness of the seed layer is increased to about 38 Å, the minimum resistance value (min. Rs) easily rises higher as compared with the single-layer seed or three-layer seed. In order to suppress a rise in the minimum resistance value (min. Rs) it is preferable that the film thickness of the seed layer in the two-layer seed be made larger than 38 Å.

As shown in FIG. 6, in the single-layer seed, if the film thickness of the seed layer is below 38 Å, the resistance changing rate (ΔR/R) declines abruptly. This is because the minimum resistance value (min. Rs), which is shown in FIG. 3, becomes larger abruptly, and consequently, and R (denominator) of the resistance changing rate (ΔR/R) becomes larger. Alternatively, in the three-layer seed, the dependency of the resistance changing rate (ΔR/R) on the film thickness of the seed is similar to the single-layer seed. However, when the resistance changing rate (ΔR/R) is evaluated in the enlarged graph of FIG. 7, it becomes higher in the three-layer seed than that in the single-layer seed. Also, in the two-layer seed, making the film thickness of the seed layer greater than 38 Å is preferable to obtain a higher resistance changing rate (ΔR/R). As shown in FIG. 7, a higher resistance changing rate (ΔR/R) can be obtained in the two-layer seed than that in the single-layer seed.

The preferable numerical range of the two-layer seed will be described. It is preferable that the film thickness of the seed layer be within a range of 38 Å to 50 Å. However, if the film thickness is 38 Å, as can be seen from FIG. 6, the resistance changing rate (ΔR/R) declines more easily than that in the single-layer seed. Thus, it is more preferable that the film thickness of the seed layer be within a range of 42 Å to 50 Å. Also, as shown in FIG. 7, if the film thickness of the seed layer is in a range of 42 Å to 46 Å, the resistance changing rate (ΔR/R) can be increased more effectively than that in the single-layer seed.

Also, it is preferable that the film thickness of the Al layer in the two-layer seed be 4 Å to 8 Å. However, if the film thickness of the Al layer is increased to about 8 Å, as shown in FIGS. 6 and 7, since the film thickness of the seed layer is easily increased to about 50 Å, a higher resistance changing rate (ΔR/R) can be obtained as compared with the single-layer seed. However, since the value itself of the resistance changing rate (ΔR/R) is not much increased, it is preferable that the film thickness of the Al layer be within a range of 4 Å to 6 Å.

The preferable numeral range of the three-layer seed will be described. It is preferable that the film thickness of the seed layer be within a range of 38 Å to 50 Å. This makes it possible to obtain a higher resistance changing rate (ΔR/R) than that in the single-layer seed. It is more preferable that the seed thickness in the three-layer seed be within a range of 42 Å to 50 Å, and it is furthermore preferable that the seed thickness be within a range of 42 Å to 46 Å. As shown in FIG. 7, a resistance changing rate (ΔR/R) which is always higher than that in the single-layer seed, and the stability of the resistance changing rate (ΔR/R) against a change in the seed thickness can be obtained better than that in the single-layer seed or three-layer seed.

It is preferable that the film thickness of the Al layer in the three-layer seed be within a range of 4 Å to 8 Å, and it is more preferable that the film thickness of the Al layer be within a range of 6 Å to 8 Å. This makes it possible to stably obtain a high resistance changing rate (ΔR/R) more stably than in the single-layer seed. Also, the film thickness of the NiFeCr layer in the three-layer seed be 38 Å or less. If the seed layer in the single-layer seed is not formed to have a film thickness of 38 Å or more, a high resistance changing rate (ΔR/R) could not be obtained. It is believed that this is because the Co layer constituting the three-layer seed functions to arrange the crystallinity of the NiFeCr layer, and even if the NiFeCr layer is formed to have a small thickness of 38 Å or less, a high resistance changing rate (ΔR/R) can hereby be obtained by providing a Co layer on the NiFeCr layer.

The following Table 1 is a table showing that, when the configuration of a seed layer is changed from the resistance changing rate (ΔR/R) in a case where a single-layer seed having a film thickness of 46 Å and ΔRs, the resistance changing rate (ΔR/R) and the ΔRs have increased to some degrees. The plus values shown in Table 1 shows an increasing amount.

TABLE 1

| Film Configuration | |
|---|---|
| of Seed Layer | |
| NiFeCr/Co/Al | NiFeCr/Co |

Thickness of
Each Film (Å)

| | 36/4/6 | 34/6/6 | 30/4 | 28/6 |
|---|---|---|---|---|
| ΔR/R (%) | +0.62 | +0.44 | +0.4 | +0.3 |
| ΔRs (Ω/□) | +0.13 | +0.1 | +0.09 | +0.1 |

The evaluated seed layers were a three-layer seed in which the film thickness of a seed layer was set to 46 Å, and a two-layer seed (hereinafter referred to as ‘NiFeCr/Co seed’) of NiFeCr/Co in which the film thickness of a seed layer was set to 34 Å. The thickness of each layer is shown in Table 1. In the three-layer seed, the film thickness of the seed layer was set to 46 Å which was equal to the film thickness of a single-layer seed. Alternatively, in the NiFeCr/Co seed, the film thickness of the seed layer was set to 34 Å which is smaller than 46 Å as mentioned above.

As shown in Table 1, the resistance changing rate (ΔR/R) and ΔRs in both the three-layer seed, and the NiFeCr/Co seed were increased as compared with the single-layer seed.

As shown in Table 1, using the three-layer seed easily produces a higher resistance changing rate (ΔR/R) and ΔRs that using the NiFeCr/Co seed. In a case where the NiFeCr/Co seed is used, there an effect that a high resistance changing rate (ΔR/R) can be obtained even if the film thickness of the seed layer becomes smaller as compared with the single-layer seed, but the resistance changing rate (ΔR/R) becomes smaller as compared with the three-layer seed. If the film thickness in the NiFeCr/Co seed is increased to about 46 Å, the resistance changing rate becomes smaller than that in the single-layer seed contrary to the above. As shown in the results of Table 1, when the seed layer is formed to have almost the same thickness as that in the related art, a high resistance changing rate (ΔR/R) can be obtained as compared with the single-layer seed.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A magnetic detecting device comprising:
a magnetoresistive effect part having a fixed magnetic layer, and a free magnetic layer which faces the fixed magnetic layer with a nonmagnetic material layer therebetween and which varies in magnetization by an external magnetic field; and
a seed layer provided below the magnetoresistive effect part,
wherein the seed layer includes an Al layer laminated on an NiFeCr layer.

2. A magnetic detecting device comprising:
a magnetoresistive effect part having a fixed magnetic layer, and a free magnetic layer which faces the fixed magnetic layer with a nonmagnetic material layer therebetween and which varies in magnetization by an external magnetic field; and
a seed layer provided below the magnetoresistive effect part,
wherein the seed layer includes a Co layer laminated on an NiFeCr layer, and an Al layer laminated on the Co layer.

3. The magnetic detecting device according to claim 1,
wherein the seed layer has a film thickness of 38 Å or more and 50 Å or less.

4. The magnetic detecting device according to claim 3,
wherein the Al layer has a film thickness of 4 Å or more and 8 Å or less.

5. The magnetic detecting device according to claim 4,
wherein an antiferromagnetic layer constituting the magnetoresistive effect part is formed on the seed layer, and the fixed magnetic layer, the nonmagnetic intermediate layer, and the free magnetic layer are laminated on the antiferromagnetic layer.

6. A magnetic detecting device comprising:
a magnetoresistive effect part having a fixed magnetic layer, and a free magnetic layer which faces the fixed magnetic layer with a nonmagnetic material layer therebetween and which varies in magnetization by an external magnetic field; and
a seed layer provided below the magnetoresistive effect part,
wherein the seed layer is formed mainly of NiFeCr, and the concentration of Al in a surface region of the seed layer is higher than the concentration of Al in the other regions of the seed layer.

7. A magnetic detecting device comprising:
a magnetoresistive effect part having a fixed magnetic layer, and a free magnetic layer which faces the fixed magnetic layer with a nonmagnetic material layer therebetween and which varies in magnetization by an external magnetic field; and
a seed layer provided below the magnetoresistive effect part,
wherein a high-concentration Co region having a higher Co concentration than the other regions of the seed region and a high-concentration Al region provided above the high-concentration Co region and having a higher Al concentration than the other regions of the seed layer exist in a surface region of the seed layer.

8. The magnetic detecting device according to claim 7,
wherein the seed layer is formed to have a film thickness of 38 Å or more and 50 Å or less.

9. The magnetic detecting device according to claim 8,
wherein an antiferromagnetic layer constituting the magnetoresistive effect part is formed on the seed layer, and the fixed magnetic layer, the nonmagnetic intermediate layer, and the free magnetic layer are laminated on the antiferromagnetic layer.

10. The magnetic detecting device according to claim 2,
wherein the seed layer has a film thickness of 38 Å or more and 50 Å or less.

11. The magnetic detecting device according to claim 10,
wherein the Co layer is formed to have a film thickness of 4 Å or more and 6 Å or less.

12. The magnetic detecting device according to claim 11,
wherein an antiferromagnetic layer constituting the magnetoresistive effect part is formed on the seed layer, and the fixed magnetic layer, the nonmagnetic intermediate layer, and the free magnetic layer are laminated on the antiferromagnetic layer.

12. The magnetic detecting device according to claim 6,
wherein the seed layer is formed to have a film thickness of 38 Å or more and 50 Å or less.

13. The magnetic detecting device according to claim
wherein an antiferromagnetic layer constituting the magnetoresistive effect part is formed on the seed layer, and the fixed magnetic layer, the nonmagnetic intermediate layer, and the free magnetic layer are laminated on the antiferromagnetic layer.
